(19) United States
(12) Patent Application Publication
(10) Pub. No.: US 2024/0280730 A1
(43) Pub. Date: Aug. 22, 2024

(54) SYSTEMS AND METHODS FOR OPTICAL SYSTEMS

(71) Applicant: Meta Platforms Technologies, LLC, Menlo Park, CA (US)

(72) Inventors: Alan Kleiman Shwarsctein, Saratoga, CA (US); Zhisheng Yun, Sammamish, WA (US); Adar Magen, Sunnyvale, CA (US); Lawrence Azzano, Mercer Island, WA (US); Burkley Delesdernier Patterson, Catonsville, MD (US); Xiyu Duan, Sammamish, WA (US); Jianwei Zhang, Westborough, MA (US)

(21) Appl. No.: 18/444,408

(22) Filed: Feb. 16, 2024

Related U.S. Application Data
(60) Provisional application No. 63/485,314, filed on Feb. 16, 2023.
(60) Provisional application No. 63/495,525, filed on Apr. 11, 2023.
(60) Provisional application No. 63/499,015, filed on Apr. 28, 2023.
(60) Provisional application No. 63/499,610, filed on May 2, 2023.

(51) Int. Cl. G02B 1/14; B29D 11/00; G02B 1/04; G02B 1/111; G02B 27/01; G06F 3/01; H01R 13/24

(52) U.S. Cl. CPC G02B 1/14; B29D 11/00865; G02B 1/041; G02B 27/0172; G06F 3/015; H01R 13/2428; G02B 1/111; G02B 2207/101; G02B 2207/107

(57) ABSTRACT

A device including an antenna, a printed circuit board having a side-plated contact, and an antenna carrier that includes an integrated spring having a conductive surface, such that the conductive surface is communicatively coupled to the side-plated contact can be used in optical systems. Disclosed computer-implemented systems and methods may include a dark source that when applied as part of an augmented reality projector, can temporarily reduce the photosensitivity of a user's eyes. Furthermore, a method for forming a lens block over a substrate and hardening the lens block and a method for motion-tolerant optical heart-rate monitoring can be disclosed herein for optical systems.

### CROSS REFERENCE TO RELATED APPLICATION

This application claims priority to U.S. Application No. 63/485,314, filed 16 Feb. 2023, U.S. Application No. 63/495,525, filed 11 Apr. 2023, U.S. Application No. 63/499,015, filed 28 Apr. 2023, and U.S. Application No. 63/499,610, filed 2 May 2023, the disclosures of each of which are incorporated, in their entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a cross-sectional schematic showing a wafer level optic (WLO) stack including plural reflowable antireflective coatings (ARCs) according to some embodiments.

FIG. 2 is a cross-sectional diagram showing the assembly of an example wafer level optic (WLO) stack including co-integrated reflowable antireflective coatings according to certain embodiments.

FIG. 3 is an illustration of an antenna carrier design without integrated springs.

FIG. 4 is an illustration of an antenna carrier design with an integrated spring.

FIG. 5 is an illustration of a printed circuit board with a side-plated contact.

FIG. 6 is a flow diagram of an exemplary method for manufacturing antennas with integrated springs.

FIGS. 7-10 illustrate an overview of the systems and methods disclosed herein.

FIG. 11 illustrates components and subsystems of the systems and methods disclosed herein.

FIG. 12 is an illustration of an exemplary system that incorporates an eye-tracking subsystem capable of tracking a user's eye(s).

FIG. 13 is a more detailed illustration of various aspects of the eye-tracking subsystem illustrated in FIG. 12.

FIG. 14 is an illustration of an exemplary system architecture for motion-tolerant heart rate monitoring featuring a physical connection between a sensor array and a controller.

FIG. 15 is an illustration of exemplary configurations for an array of sensors.

FIG. 16 is a flow diagram of an exemplary method for motion-tolerant heart rate monitoring.

FIG. 17 is an illustration of an exemplary controller integrated with an array of palm-facing sensors.

FIG. 18 is an illustration of an exemplary hand gripping a controller integrated with an array of palm-facing sensors.

FIG. 19 is an illustration of an exemplary controller that includes an array of sensors integrated in a battery cover of the controller.

FIG. 20 is an illustration of an exemplary controller that includes a grip cover integrated with an array of sensors.

FIG. 21 is an illustration of an exemplary palm that includes an array of sensors for heart rate monitoring.

FIG. 22 is an illustration of exemplary output readings for each of the sensors in the array of sensors.

FIG. 23 is an illustration of an exemplary palm that includes an array of sensors during a mid-intensity boxing motion, highlighting a sensor at the upper left corner of the palm.

FIG. 24 is an illustration of an exemplary sensor output reading at the upper left corner of the palm during a mid-intensity boxing motion.

FIG. 25 is an illustration of an exemplary palm that includes an array of sensors during a mid-intensity boxing motion, highlighting a sensor at the bottom of the palm.

FIG. 26 is an illustration of an exemplary sensor output reading at the bottom of the palm during a mid-intensity boxing motion.

FIG. 27 is an illustration of an exemplary palm that includes an array of sensors during a mid-intensity boxing motion, highlighting a sensor at the upper right corner of the palm.

FIG. 28 is an illustration of an exemplary sensor output at the upper right corner of the palm during a mid-intensity boxing motion.

FIG. 29 is an illustration of exemplary augmented-reality glasses that may be used in connection with embodiments of this disclosure.

FIG. 30 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Optical polymer or glass elements replicated on glass or polymer substrates may be used to fabricate micro-optic components for laser optics, sensing applications, and imaging applications, including refractive and diffractive optical elements, waveguides, meta lenses, IR and UV filters, and the like. Various softening, forming, and finishing methods may be used to form low loss, high-precision components. The co-integration of polymer layers with interference coatings such as anti-reflection coatings may be challenged, however, by a mismatch in the coefficient of thermal expansion (CTE) between the different layers. In addition to CTE mismatch-induced mechanical failure, interference coatings may induce undesired spectral shift due to angle of incidence (AOI) and thickness variability during deposition particularly resulting from high sag in wafer level optics (WLO) elements.

As will be appreciated, reflow processes may be used to form lens structures. These processes typically include heating a lens material above its softening point to shape the lens and then hardening the lens material to maintain a desired shape. In example processes, a nanostructured layer such as an antireflective coating (ARC) may be co-integrated into a lens structure.

Augmented and virtual reality systems are increasingly commonplace. For example, an augmented reality system can project virtual objects into a user's eyes (e.g., via a pair of augmented reality glasses) such that the user views the virtual objects overlaid on the environment within the user's natural gaze. While such augmented reality (AR) systems generally present clear and bright AR objects while a user is indoors or in darker environments (e.g., in the shade), typical AR systems suffer multiple shortcomings when used in environments with brighter light levels. For example, a typical AR system must project virtual objects at a very bright level for a user to see those virtual objects when standing outside during the daytime. Projecting at such levels of brightness, however, can create a power drain within the device where the projector resides which—in turn—reduces the battery life of that device.

Thus, disclosed are various methods for manufacturing wafer level optic. An example method includes forming a lens block over a substrate, forming a nanostructured coating over the lens block opposite to the substrate, and hardening the lens block. The nanostructured coating may be configured as an interference coating such as an antireflective coating where the nanostructured coating may be configured to decrease the reflectance of visible light and IR radiation at least along a transmissive axis of the lens block. Also disclosed is the manufacture, design, assembly, and implementation of antennas for wearable electronic devices. Tolerances for manufacturing and assembling antennas for mobile devices can often be tight, and inadequate accuracy may result in loss of signal quality for the assembled antennas. This disclosure is directed to addressing the problems of inconsistency and the tolerance-based variability of antenna design, and in particular how antenna connections to other electronics may be affected by manufacturing processes. Also disclosed is a subtractive contrast system that introduces laser light into the user's eyes to temporarily modulate the sensitivity of the user's photoreceptors. By reducing photoreceptor sensitivity, the subtractive contrast system can temporarily make the environment viewed by the user appear darker such that virtual objects viewed within that environment appear brighter. In this way, the subtractive contrast system can project virtual objects at lower brightness levels with less power output. This can result in longer battery life and extended usage periods associated with AR devices where the subtractive contrast system is implemented. Also disclosed is a method for motion-tolerant optical heart rate monitoring in VR/AR controllers. For example, the systems described herein may recalibrate an array of sensors to find a different sensing location in response to detecting movement or pressure from the controller.

Features from any of the implementations described herein may be used in combination with one another in accordance with the general principles described herein. These and other implementations, features, and advantages will be more fully understood upon reading the following detailed description in conjunction with the accompanying claim.

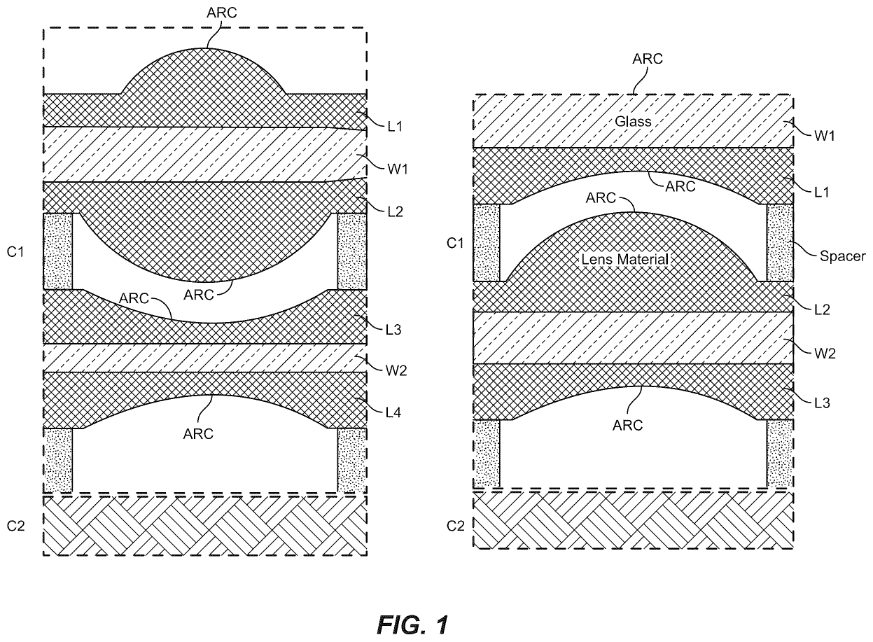

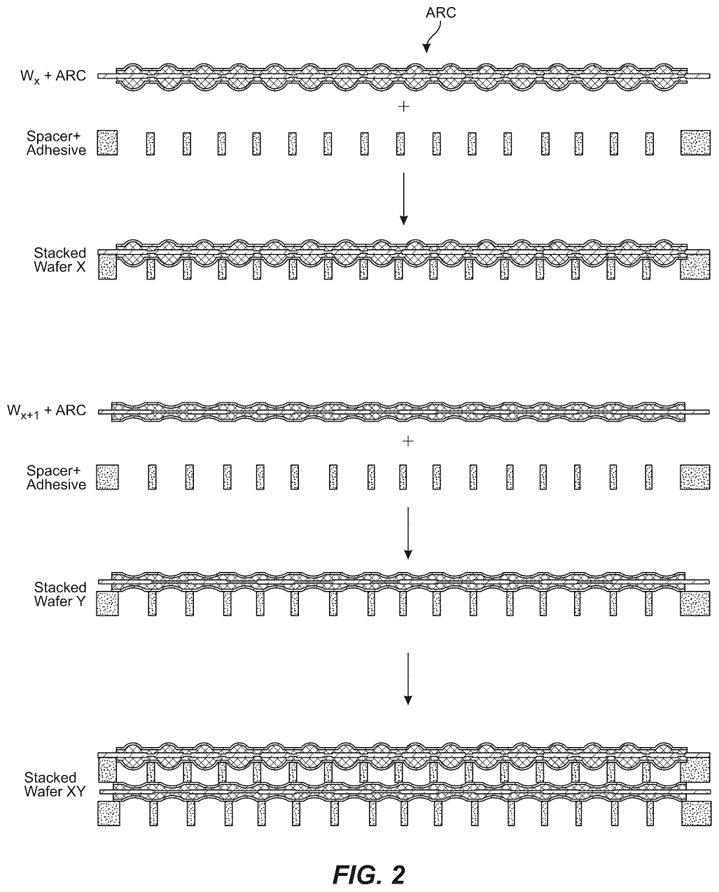

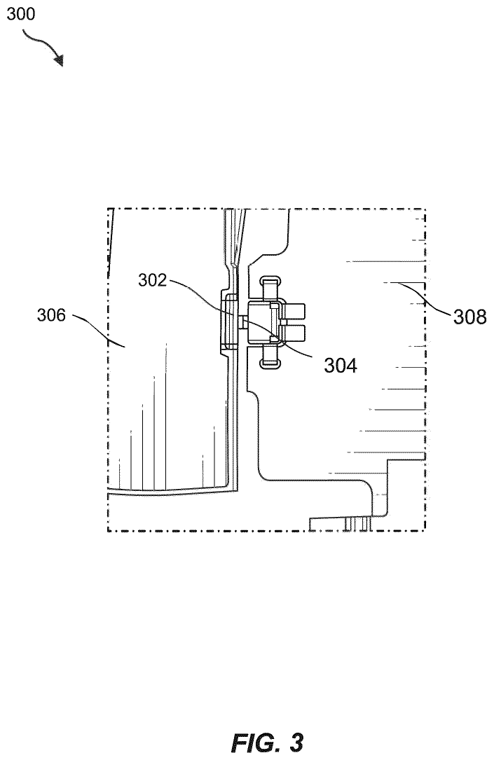

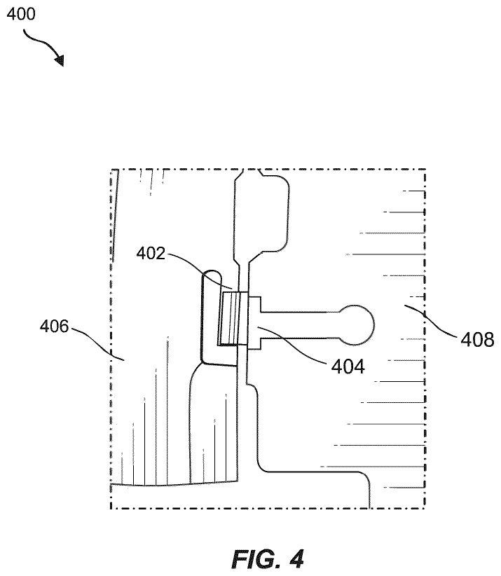

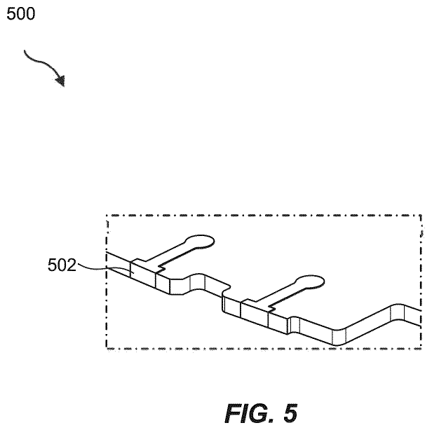

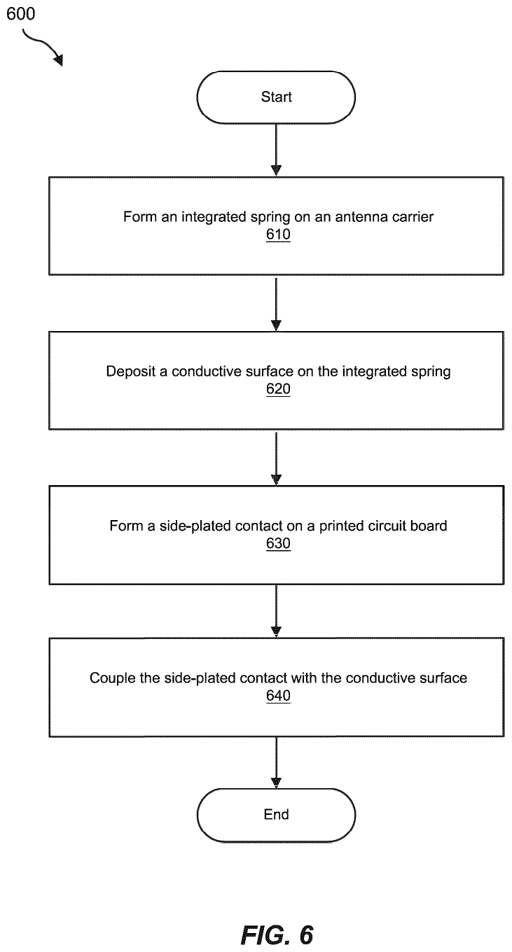

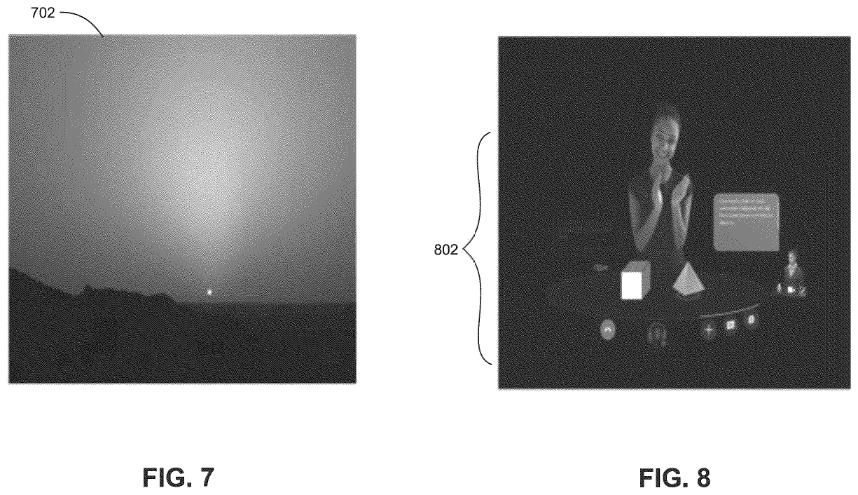

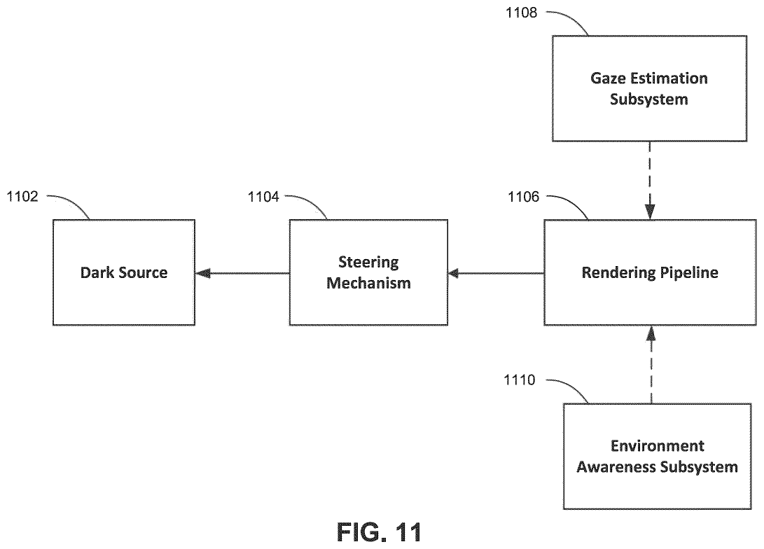

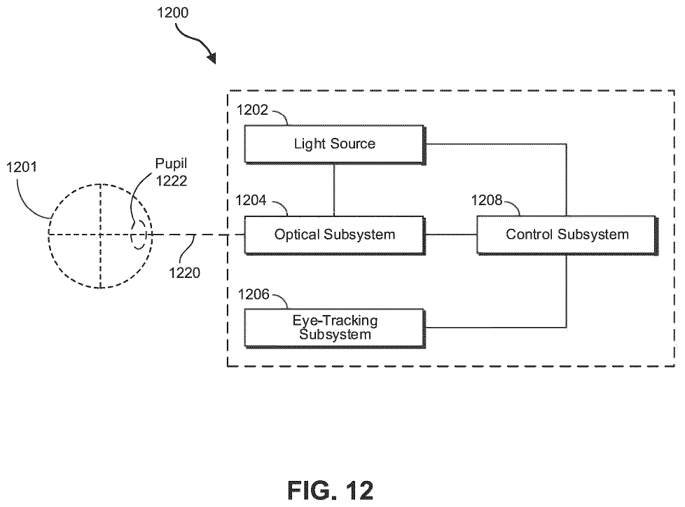

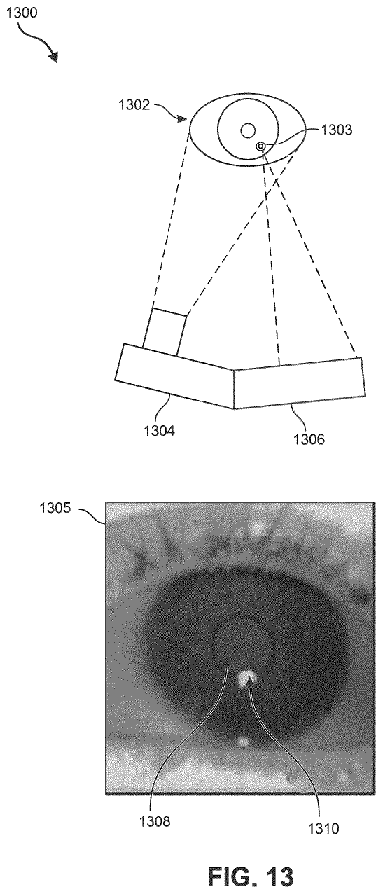

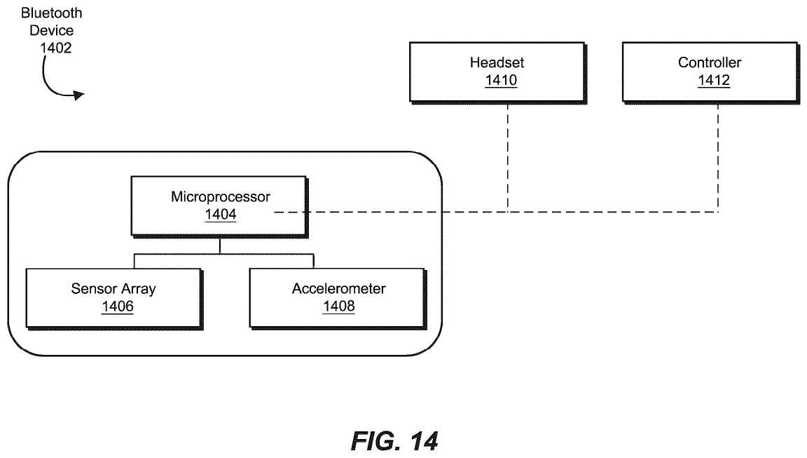

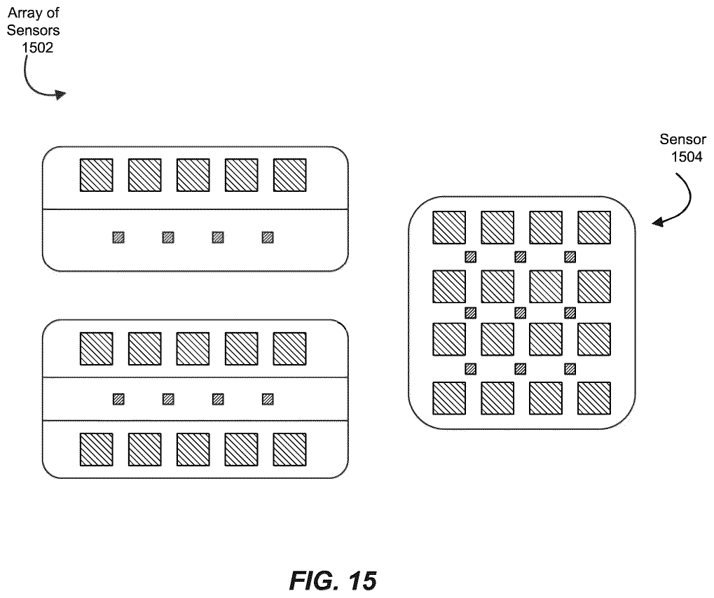

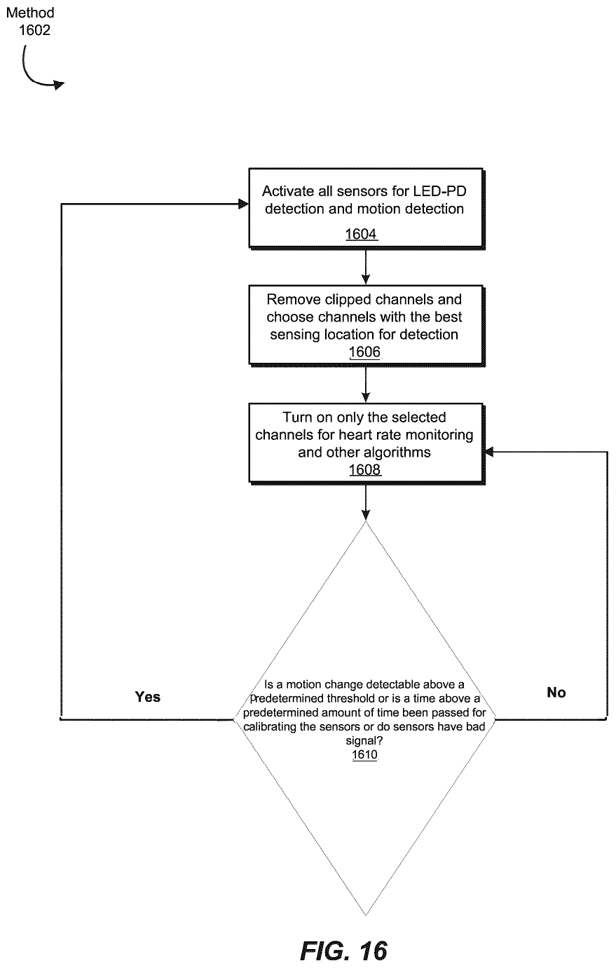

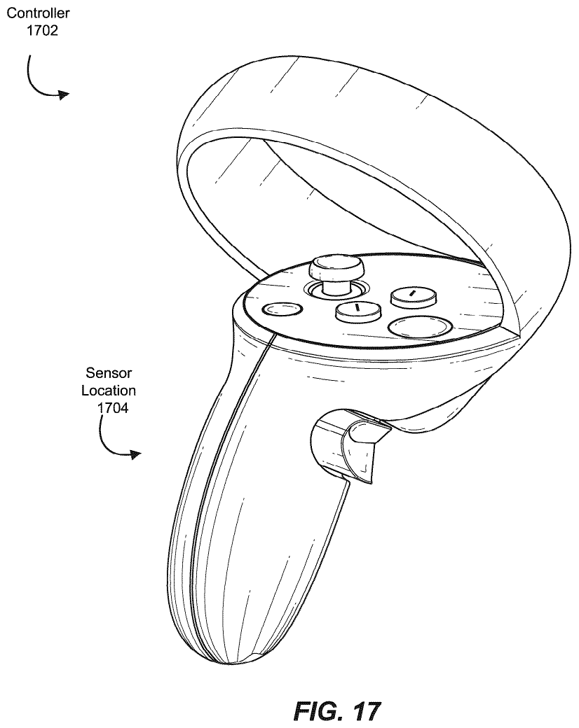

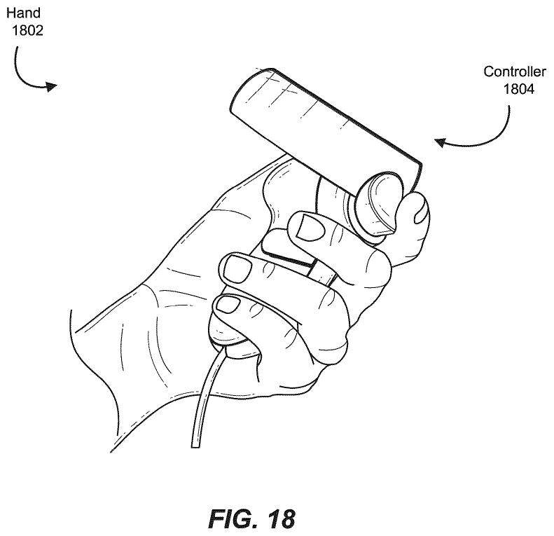

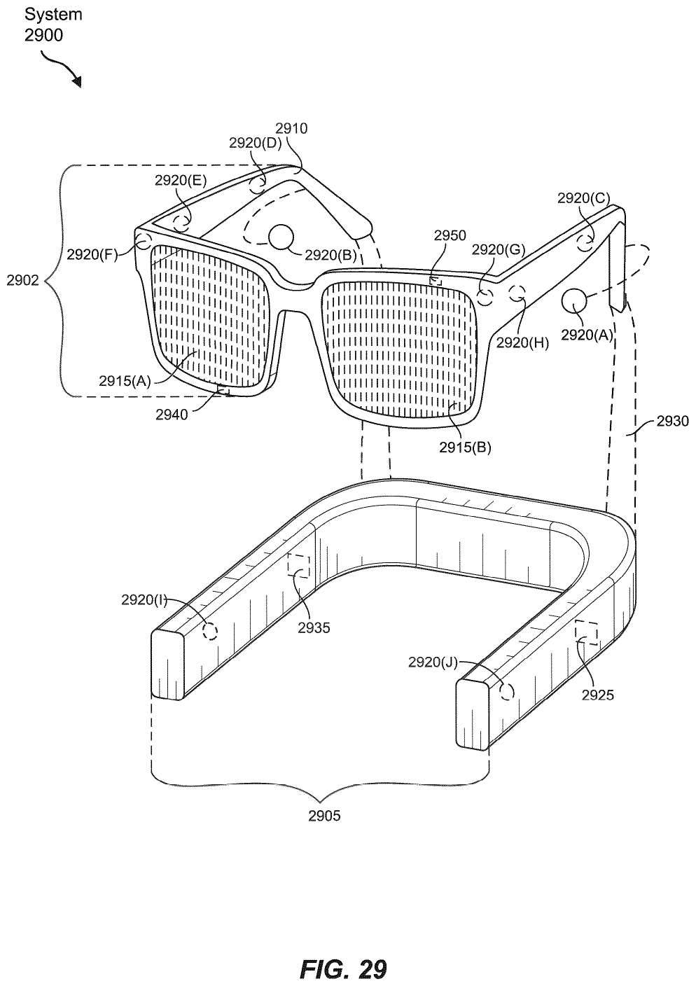

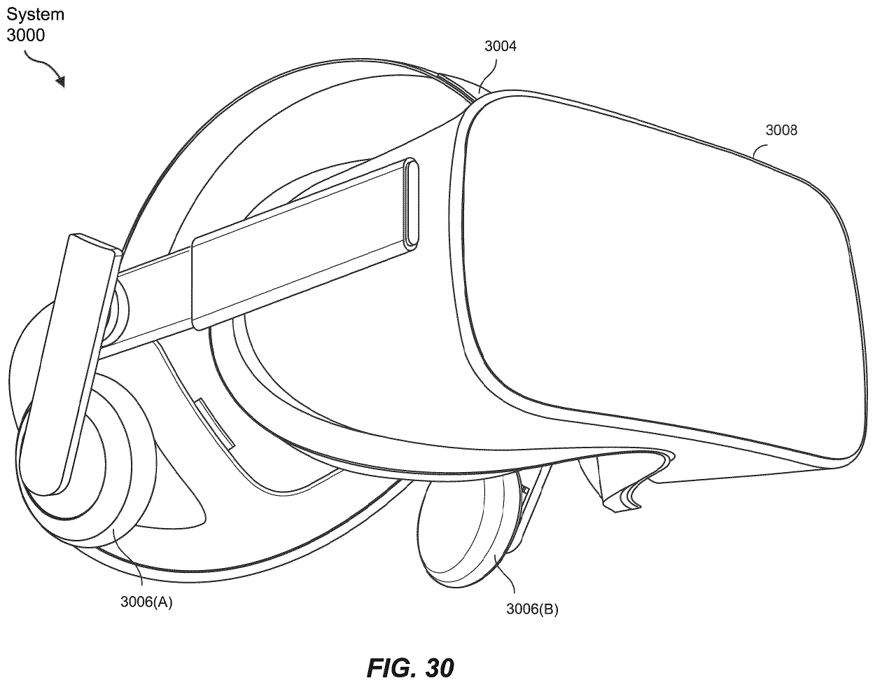

The following will provide, with reference to FIGS. 1-30, detailed descriptions of methods for the systems and methods for AR/VR displays. The discussion associated with FIGS. 1 and 2 includes a description of methods of forming a lens architecture having one or more co-integrated antireflective layers. The discussion associated with FIGS. 3 and 4 includes a description of antenna carrier design. The discussion associated with FIG. 5 includes a description of a printed circuited board with a side-plated contact. The discussion associated with FIG. 6 includes a description of a method for manufacturing antennas with integrated springs. The discussion associated with FIGS. 7-10 includes a description for a subtractive contrast system. The discussion associated with FIG. 11 includes a description of a method for implementing a dark source using a subtractive contrast system. The discussion associated with FIGS. 12 and 13 included a description for incorporating an eye-tracking subsystem capable of tracking a user's eye. The discussion associated with FIG. 14 includes a system architecture featuring communication between the sensors and the controller. The discussion associated with FIG. 15 includes embodiments of a sensor array. The discussion associated with FIG. 16 includes a description for a method of motion-tolerant heart rate monitoring in a VR/AR controller. The discussion associated with FIGS. 17-21 include configurations of palm facing sensors integrated in a controller. The discussion associated with FIGS. 22-28 may include output readings of the sensors during mid-level intensity exercise. The discussion associated with FIGS. 29 and 30 relates to exemplary virtual reality and augmented reality devices that may include a lens architecture having a reflow-capable antireflective coating as disclosed herein.

### Reflowable Anti Reflective Coating for Wafer Level Optics

In certain examples, the nanostructured coating may be formed directly over the lens block. Suitable nanostructured coatings may include a nanoporous oxide such as nanoporous titanium oxide, or a nanoporous polymer such as nanoporous polytetrafluoroethylene or another low refractive index fluoropolymer. Particular polymeric nanostructured coatings may include a textured polymer coating, a nanoparticulate bi-layer coating, or a double layer antireflection coating. A nanostructured coating may have a refractive index of less than approximately 1.5.

An example method of forming the nanostructured coating over the lens block may include spray coating such as spray coating a sol gel composition. Hardening of the lens block may include exposing the lens block to ultraviolet light. The method may be arranged such that a coefficient of thermal expansion of the lens block and a coefficient of thermal expansion of the nanostructured coating are substantially equal. According to particular examples, the method may include heating the coated lens block in an amount effective to reflow the lens block where the lens block and the nanostructured coating may be substantially CTE matched throughout the act of heating the coated lens block. In some instantiations, a second nanostructured coating may be formed directly over the substrate opposite to the lens block.

According to further embodiments, a method may include forming a resinous lens block over a glass substrate and forming a nanostructured coating over the lens block opposite to the substrate, where a coefficient of thermal expansion of the lens block and a coefficient of thermal expansion of the nanostructured coating are substantially equal. Accordingly, a lens structure may include a glass substrate, a resinous lens disposed over the glass substrate, and a nanostructured coating disposed directly over the resinous lens.

Referring to FIG. 1, illustrated is a cross-sectional view of an example lens architecture including a substrate or sensor package (C1) and an over-formed wafer level optic (C2). In some embodiments, the lens architecture may be configured as a stack that includes glass wafers (W1 and W2) and polymer lenses (L1-L3 or L1-L4). The respective polymer layers may be formed throughout a successive build-up of the stack by spin-coating a suitable resin followed by radiative (e.g., UV) and/or thermal curing.

Antireflective coatings (ARCs) formed from nanostructured materials may be incorporated into the lens architecture, i.e., between adjacent glass and polymer layers and, in contrast to comparative low CTE oxide-based antireflective coatings, may exhibit improved mechanical compatibility with the lens module particularly during elevated temperature processing such as reflow processing. In some examples, a nanostructured coating may be formed directly over a concave or a convex surface of a polymer lens.

In further embodiments, a polymer layer may be formed over a lens and one or both of the polymer layer and the lens material may be etched to introduce porosity that decreases the effective refractive index of the structure. For instance, an etching step may introduce a lower refractive index nanostructure over a depth of approximately 0.1 to 10 micrometers. As an alternative to etching, in still further examples, a chemical foaming agent may be used to introduce porosity. The presently-disclosed nanostructured coatings thus provide an antireflective function in conjunction with associated processing that is reflow-compatible.

Referring to FIG. 2, a wafer level optic may be manufactured by separately forming various sub-structures, such as sub-structures that each include a single glass wafer and respective over-formed nanostructured coatings, and then aligning and stacking the sub-structures to form a lens module. Multiple lens modules may be formed over a large-area substrate and subsequently harvested using suitable dicing operations.

Disclosed are nanostructured thin films that have a decreased CTE mismatch with resinous lenses that may be implemented as interference coatings in wafer level optics manufacturing. The nanostructured thin films may be mechanically stable at elevated temperatures (T>250° C.), including reflow processing used to manufacture polymer-glass composite substrates and lenses. Example nanostructured thin films include grazing angle coatings such as porous oxides (e.g., TiO₂), textured polymer coatings, and nanoporous coatings such as sprayable sol gel thin films. Such nanostructured thin films may improve reliability by decreasing CTE mismatch, decreasing water vapor transmission rates (WVTR), and increasing light collection efficiencies.

Antenna Carriers with Integrated Springs

The term antenna, in some examples, may generally refer to any type or form of interface between radio waves propagating through space and electric currents moving through metal conductors. In transmission, a radio transmitter may send an electric current to an antenna's terminal, and in response, the antenna may radiate energy from the current as electromagnetic waves. In reception, an antenna may intercept some of the power of a radio wave to produce an electric current at its terminal. Antennas are essential components of radio equipment, and the term “radio,” in some examples, may include multiple parts of an antenna feed structure including amplifiers, tuners, impedance matching circuits, transmitters, receivers, filters, or other electronic components used in the transmission or reception of wireless signals.

With antennas in mobile devices, having a consistent connection between the transmitting/receiving element and the circuit board is very important. Traditional approaches for coupling antennas to printed circuit boards may involve using a mechanical spring connection between the carrier and the printed circuit board. In such configurations, the mechanical spring is intended to absorb the tolerance variability between the circuit board on one side and the antenna on the other side.

FIG. 3 shows an example of a system 300 with a plated surface 302 on an antenna carrier 306 in contact with a clip spring 304 that electrically couples an antenna carried by carrier 306 to other electronics on a printed circuit board 308. In such embodiments, contact impedance between clip spring 304 and plated surface 302 may depend on tolerances of printed circuit board outlines, printed circuit board placement within a device, clip manufacturing tolerances, surface mount placement tolerances, carrier molding formation tolerances, carrier placement tolerances, and/or a variety of other factors.

FIG. 4 shows an example system 400 according to embodiments of the present disclosure. The design of system 400 may simplify an electrical coupling design by integrating a spring 402 into an antenna carrier 406 instead of coupling a separate spring to a printed circuit board. In the embodiment shown in FIG. 4, spring 402 may be an integrated cantilever beam element in a plastic antenna carrier, and any other suitable spring design may be used. This beam element may with be plated with conductive plating and may make contact with an antenna carried by carrier 406 and with circuit board 408 at a plated zone 404 to electrically couple the antenna to other components on circuit board 408. In the example shown in FIG. 4, the plated zone 404 may extend over the edge of circuit board 408 such that it comes into contact laterally with integrated spring 402 (e.g., via a side contact 502 on printed circuit board 500, as shown in FIG. 5). Such designs eliminate the need for a clip spring and the inherent tolerances of manufacturing and positioning springs on a circuit board, which may facilitate improved connection impedance between an antenna carrier and a printed circuit board. In other words, embodiments of the present disclosure may reduce the amount of tolerance inherent in a loop that runs from a circuit board to the placement of a metal spring to the plating on an antenna carrier and the relative positioning of each of these elements. Also, while FIG. 4 shows a cantilevered beam spring, any other suitable spring geometry could be integrally molded into an antenna carrier (e.g., leaf springs, coil springs, etc.)

Plating may be deposited on integrated springs and/or printed circuit boards in any suitable manner. In some embodiments, plating may be deposited using laser direct structuring, which may use a thermoplastic material, doped with a non-conductive metallic inorganic compound activated by means of laser. A laser may then write the course of the circuit trace (e.g., the plating disclosed herein) on the plastic. Any suitable material may be used for such plating, including copper, nickel, and gold.

FIG. 6 shows a method 600 for manufacturing an antenna carrier according to embodiments on the present disclosure. As shown in FIG. 6, at step 610, a manufacturing system may form an integrated spring on an antenna carrier. At step 620, the manufacturing system may deposit a conductive surface on the integrated spring, and at step 630 the manufacturing system may form a side-plated contact on a printed circuit board. Finally, at step 640, the manufacturing system may couple the side-plated contact with the conductive surface.

As discussed above, embodiments of the present disclosure may simplify antenna carrier and electrical coupling design by integrating a spring into a carrier instead of coupling a separate spring on a printed circuit board. In this manner, the systems described herein may provide for more efficient and/or effective manufacture, design, assembly, and implementation of radio frequency connections between printed circuit boards and antenna carriers in a manner that shortens tolerance loops, reduces contact impedance, and lowers cost.

### Subtractive Contrast

As mentioned above, typical AR systems have to compete with the environment being viewed by a user. When that environment is bright—such as when the user is positioned outdoors during the daytime—typical AR systems have to project virtual objects at increased brightness levels so that those objects can be viewed against the environment. To illustrate, FIG. 7 shows an environment 702 that includes a bright light source (e.g., the sun). Additionally, FIG. 8 shows a selection of virtual objects 802 that may be projected into a user's eyes such that the virtual objects appear overlaid on the environment 702. A typical AR system would have to project the virtual objects 802 at a high brightness level into the user's eyes in order for the user to be able to view the virtual objects 802 overlaid on the environment 702.

Rather than increasing the brightness level of the virtual objects 802, the subtractive contrast system can add a dark source (e.g., an alpha channel or fourth channel) to a red/green/blue (RGB) projector that effectively “subtracts” light from a user's eyes by temporarily reducing the photosensitivity of the user's eyes relative to one or more regions of an AR display. For example, the subtractive contrast system can introduce a deep blue wavelength laser into the alpha channel that briefly reduces sensitivity in different regions of the user's retina. More specifically, by introducing certain laser wavelengths and waveforms into the user's retina, the subtractive contrast system can temporarily modulate the sensitivity of the photoreceptors in the user's eyes. Thus, using conventional AR projector architectures, the subtractive contrast system can paint the user's retina with this laser light to apply subtractive contrast using ambient light.

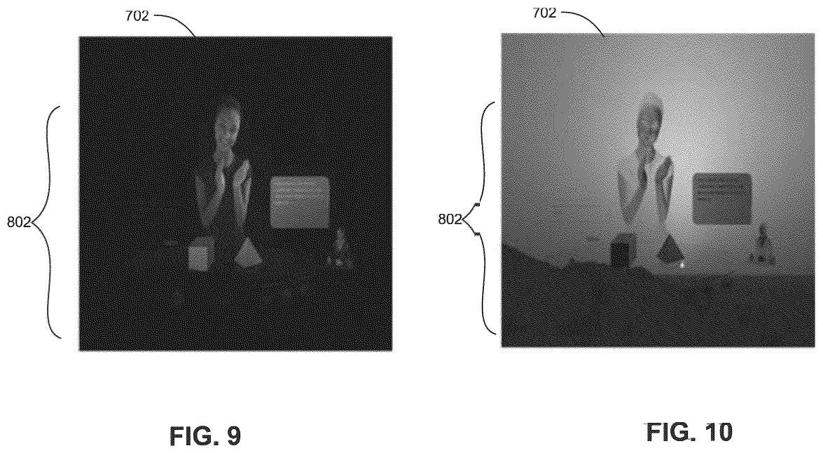

To illustrate, as shown in FIG. 9, the subtractive contrast system can pulse a laser with one or more wavelengths and waveforms into the eyes of a user viewing the environment 702 as part of an AR display including the virtual objects 802. For example, the subtractive contrast system can pulse the laser to reduce the photosensitivity of the user's eyes such that the environment 702 is dimmed to the point that the virtual objects 802 are easily viewed. In another implementation, as shown in FIG. 10, the subtractive contrast system can modulate the laser pulses such that the environment 702 is dimmed to a lesser extent such that the environment 702 is still viewable while the virtual objects 802 appear brighter.

In this way, the subtractive contrast system applies the dark source such that the AR display laser(s) needs to provide enough power to modulate the user's photoreceptors, rather than providing enough power to compete with ambient light within the environment 702. It follows that the subtractive contrast system can increase the effective brightness and contrast of an AR display as ambient light becomes brighter within the environment 702. In additional implementations, the subtractive contrast system can include different types of light as the dark source to introduce subtractive contrast within an AR display. For example, the subtractive contrast system can include ultraviolet light as the dark source within an AR projector.

In one or more implementations, as discussed above, the subtractive contrast system can apply a dark source to an AR display device to reduce the photosensitivity of a user's eyes as the user views an environment overlaid with virtual objects. In at least one implementation, the subtractive contrast system can include additional elements and subsystems to apply the dark source effectively and accurately. For example, as shown in FIG. 11, the subtractive contrast system can include the dark source 1102. As discussed above, the dark source 1102 can include a fourth channel (e.g., an alpha channel) in an RGB display generator that pulses various waveforms and/or wavelengths of deep blue light into regions of the user's retina to reduce the photosensitivity of those regions.

To accurately apply the dark source to the user's retina, the subtractive contrast system can further include a steering mechanism 1104. For example, the steering mechanism 1104 can direct the dark source to regions of the user's retina based on placements of one or more virtual objects (e.g., the virtual objects 802) that are to be rendered into an AR display. As discussed above, the steering mechanism 1104 can direct the dark source to regions of the user's retina that result in dimming of the entire environment 702 (e.g., such as in FIG. 9). Additionally or alternatively, the steering mechanism 1104 can direct the dark source to regions of the user's retina such that a dim halo exists around the virtual objects 802 while the remainder of the surrounding environment 702 appears unchanged within the AR display.

Moreover, as shown in FIG. 11, the subtractive contrast system can include a rendering pipeline 1106 that renders the augmented reality display incorporating the dark source. For example, the rendering pipeline 1106 can render the virtual objects 802 into the AR display viewed by the user at brightness levels that correlate with the reduced retinal photosensitivity created by the dark source.

In one or more implementations, the subtractive contrast system can optionally include a gaze estimation subsystem 1108 and an environment awareness subsystem 1110. For example, the gaze estimation subsystem 1108 can utilize one or more eye tracking methodologies to determine a direction of the user's eyes relative to the environment 702. Moreover, the environment awareness subsystem 1110 can include one or more externally facing cameras to determine light levels of the surrounding environment 702. Based on the direction of the user's eyes and the light levels of the surrounding environment 702, the subtractive contrast system can apply subtractive contrast to certain areas of an AR display to effectively brighten those areas. Additionally, in some implementations, the subtractive contrast system can apply additive contrast to additional areas of the AR display to effectively darken those areas. In this way, the subtractive contrast system can utilize the dark source 1102 in concert with additive contrast to evenly illuminate all regions of an AR display.

FIG. 12 is an illustration of an exemplary system 1200 that incorporates an eye-tracking subsystem capable of tracking a user's eye(s). As depicted in FIG. 12, system 1200 may include a light source 1202, an optical subsystem 1204, an eye-tracking subsystem 1206, and/or a control subsystem 1208. In some examples, light source 1202 may generate light for an image (e.g., to be presented to an eye 1201 of the viewer). Light source 1202 may represent any of a variety of suitable devices. For example, light source 1202 can include a two-dimensional projector (e.g., a LCOS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1204 may receive the light generated by light source 1202 and generate, based on the received light, converging light 1220 that includes the image. In some examples, optical subsystem 1204 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1220. Further, various mechanical couplings may serve to maintain the relative spacing and/or the orientation of the optical components in any suitable combination.

In one embodiment, eye-tracking subsystem 1206 may generate tracking information indicating a gaze angle of an eye 1201 of the viewer. In this embodiment, control subsystem 1208 may control aspects of optical subsystem 1204 (e.g., the angle of incidence of converging light 1220) based at least in part on this tracking information. Additionally, in some examples, control subsystem 1208 may store and utilize historical tracking information (e.g., a history of the tracking information over a given duration, such as the previous second or fraction thereof) to anticipate the gaze angle of eye 1201 (e.g., an angle between the visual axis and the anatomical axis of eye 1201). In some embodiments, eye-tracking subsystem 1206 may detect radiation emanating from some portion of eye 1201 (e.g., the cornea, the iris, the pupil, or the like) to determine the current gaze angle of eye 1201. In other examples, eye-tracking subsystem 1206 may employ a wavefront sensor to track the current location of the pupil.

Any number of techniques can be used to track eye 1201. Some techniques may involve illuminating eye 1201 with infrared light and measuring reflections with at least one optical sensor that is tuned to be sensitive to the infrared light. Information about how the infrared light is reflected from eye 1201 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1206 may be digitized (i.e., converted to an electronic signal). Further, the sensor may transmit a digital representation of this electronic signal to one or more processors (for example, processors associated with a device including eye-tracking subsystem 1206). Eye-tracking subsystem 1206 may include any of a variety of sensors in a variety of different configurations. For example, eye-tracking subsystem 1206 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1206 to track the movement of eye 1201. In another example, these processors may track the movements of eye 1201 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1206 may be programmed to use an output of the sensor(s) to track movement of eye 1201. In some embodiments, eye-tracking subsystem 1206 may analyze the digital representation generated by the sensors to extract eye rotation information from changes in reflections. In one embodiment, eye-tracking subsystem 1206 may use corneal reflections or glints (also known as Purkinje images) and/or the center of the eye's pupil 1222 as features to track over time.

In some embodiments, eye-tracking subsystem 1206 may use the center of the eye's pupil 1222 and infrared or near-infrared, non-collimated light to create corneal reflections. In these embodiments, eye-tracking subsystem 1206 may use the vector between the center of the eye's pupil 1222 and the corneal reflections to compute the gaze direction of eye 1201. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1206 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1201 may act as a retroreflector as the light reflects off the retina, thereby creating a bright pupil effect similar to a red-eye effect in photography. If the illumination source is offset from the optical path, then the eye's pupil 1222 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1208 may control light source 1202 and/or optical subsystem 1204 to reduce optical aberrations (e.g., chromatic aberrations and/or monochromatic aberrations) of the image that may be caused by or influenced by eye 1201. In some examples, as mentioned above, control subsystem 1208 may use the tracking information from eye-tracking subsystem 1206 to perform such control. For example, in controlling light source 1202, control subsystem 1208 may alter the light generated by light source 1202 (e.g., by way of image rendering) to modify (e.g., pre-distort) the image so that the aberration of the image caused by eye 1201 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

FIG. 13 is a more detailed illustration of various aspects of the eye-tracking subsystem illustrated in FIG. 12. As shown in this figure, an eye-tracking subsystem 1300 may include at least one source 1304 and at least one sensor 1306. Source 1304 generally represents any type or form of element capable of emitting radiation. In one example, source 1304 may generate visible, infrared, and/or near-infrared radiation. In some examples, source 1304 may radiate non-collimated infrared and/or near-infrared portions of the electromagnetic spectrum towards an eye 1302 of a user. Source 1304 may utilize a variety of sampling rates and speeds. For example, the disclosed systems may use sources with higher sampling rates in order to capture fixational eye movements of a user's eye 1302 and/or to correctly measure saccade dynamics of the user's eye 1302. As noted above, any type or form of eye-tracking technique may be used to track the user's eye 1302, including optical-based eye-tracking techniques, ultrasound-based eye-tracking techniques, etc.

Sensor 1306 generally represents any type or form of element capable of detecting radiation, such as radiation reflected off the user's eye 1302. Examples of sensor 1306 include, without limitation, a charge coupled device (CCD), a photodiode array, a complementary metal-oxide-semiconductor (CMOS) based sensor device, and/or the like. In one example, sensor 1306 may represent a sensor having predetermined parameters, including, but not limited to, a dynamic resolution range, linearity, and/or other characteristic selected and/or designed specifically for eye tracking.

As detailed above, eye-tracking subsystem 1300 may generate one or more glints. As detailed above, a glint 1303 may represent reflections of radiation (e.g., infrared radiation from an infrared source, such as source 1304) from the structure of the user's eye. In various embodiments, glint 1303 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 13 shows an example image 1305 captured by an eye-tracking subsystem, such as eye-tracking subsystem 1300. In this example, image 1305 may include both the user's pupil 1308 and a glint 1310 near the same. In some examples, pupil 1308 and/or glint 1310 may be identified using an artificial-intelligence-based algorithm, such as a computer-vision-based algorithm. In one embodiment, image 1305 may represent a single frame in a series of frames that may be analyzed continuously in order to track the eye 1302 of the user. Further, pupil 1308 and/or glint 1310 may be tracked over a period of time to determine a user's gaze.

In one example, eye-tracking subsystem 1300 may be configured to identify and measure the inter-pupillary distance (IPD) of a user. In some embodiments, eye-tracking subsystem 1300 may measure and/or calculate the IPD of the user while the user is wearing the artificial reality system. In these embodiments, eye-tracking subsystem 1300 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspects of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1200 and/or eye-tracking subsystem 1300 may be incorporated into augmented-reality system 1400 in FIG. 14 to enable these systems to perform various eye-tracking tasks (including one or more of the eye-tracking operations described herein).

### Optical Heart Rate Monitoring

FIG. 14 is an illustration of an exemplary system architecture for motion-tolerant heart rate monitoring featuring a physical connection between a sensor array and a controller. Bluetooth device 1402 harbors the communication between a sensor array 1406 and a controller 1412. The term “controller” may refer to controllers that assist users to perform certain actions in a virtual world. Examples of Bluetooth devices may include, without limitation, sensors, remotes, fitness trackers etc. Bluetooth device 1402 may include a microprocessor 1404, sensor array 1406, and an accelerometer 1408. According to some embodiments, the physical connection between Bluetooth device 1402 and controller 1412 may represent integration of the Bluetooth device 1402 within the controller 1412. In one embodiment, the physical connection as shown in FIG. 14 may represent the integration of the Bluetooth device 1402 in the headset 1410.

FIG. 15 is an illustration of the exemplary configurations for an array of sensors in a controller. For example, the systems described here may represent an array of sensors 1502 by three different embodiments of sensors 1504 as shown in FIG. 15. The term “sensor” may generally refer to a device that detects and measure a heart or a pulse rate for heart rate monitoring. Examples of sensors for heart rate monitoring may include, without limitation, electrical sensors known as electrocardiography (ECG) or optical sensors known as photoplethysmography (PPG). In one embodiment, PPG sensors may include light emitting diodes (LEDs) to measure volumetric variations of blood circulation within the skin. Sensors 1504 may represent three different embodiments to make up an array of sensors 1502. For example, sensors 1504 may include a 1×5 array, 2×5 array, 4×4 array, etc.

FIG. 16 is a flow diagram of an exemplary method 1602 for motion-tolerant heart rate monitoring. In some embodiments, the steps shown here may perform any suitable computer-executable code and/or computing system. In one example, each of the steps shown in FIG. 16 may represent an algorithm whose structure includes and/or is represented by multiple sub-steps, examples of which will be provided in greater detail below.

Method 1602 includes several steps involved in a motion-tolerant heart rate monitoring process. As illustrated in FIG. 16, one or more of the systems described herein may determine the best sensing location for heart rate monitoring. For example, one or more of the systems described here may select the most optimal sensor in an array of sensors. As noted above, the sensor array may be part of a controller or a headset for heart rate monitoring.

At step 1604, the systems described herein may activate all sensor locations for LED-PD detection and motion detection. For example, the array of sensors may activate to determine the best sensing location by calibrating PPG sensors to detect a user's heart rate at a location that may provide the best signal. In some embodiments, PPG sensors in a PPG sensor array may activate in response to detecting external motion from a controller.

Furthermore, as the controller is held by the user, an evaluation on the output of each sensor for signal quality may be done. At step 1606, the systems described herein may turn off selected channels for the sensors that may not be in a location suitable for sensing based on the strength of the signal quality. The systems described herein may select the channels for the sensors in the most suitable locations based on evaluating the outputs of the signals for the remaining sensors left in the array. At step 1608, the channels for the selected sensors may turn on for heart rate monitoring. In some embodiments, algorithms that may calibrate for specific motions, (based on a pattern, program, etc.) turn on for heart rate monitoring.

At step 1610, the array of sensors may recalibrate due to a variety of factors that may be present during heart rate monitoring. For example, a change in motion above a predetermined threshold during heart rate monitoring may prompt a recalibration of the sensors in response to the detected movement. In one embodiment, the sensors may recalibrate to determine a new sensing location with better signal quality, away from the detected movement. In further embodiments, at step 1610, the array of sensors may recalibrate in response to determining that a predetermined amount of time has been passed since a previous calibration of the sensors. In some embodiments, at step 1610, the array of heart sensors may recalibrate in response to poor signal quality for heart rate monitoring.

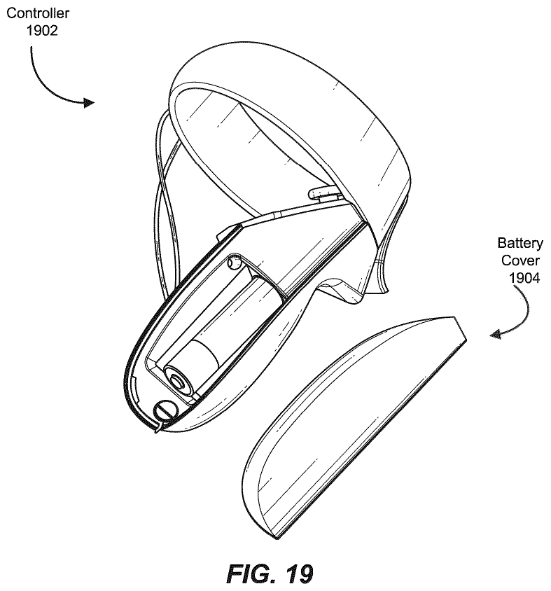

FIG. 17 is an illustration of an exemplary controller integrated with heart rate sensors that may be palm facing. In some embodiments, the controller 1702 may include the heart rate sensors natively at a sensor location 1704. Sensors at sensor location 1704 may integrate in the controller palm facing to conveniently detect a user's grip for heart rate monitoring. FIG. 18 is an illustration of an exemplary hand of a user gripping a controller integrated with palm facing sensors. Controller 1804 may include the heart rate sensors natively, where the sensors are facing the palm of a hand 1802. Hand 1802 may position itself to a grip controller 1804, where the array of sensors integrated within controller 1804 span across a hand 1802.

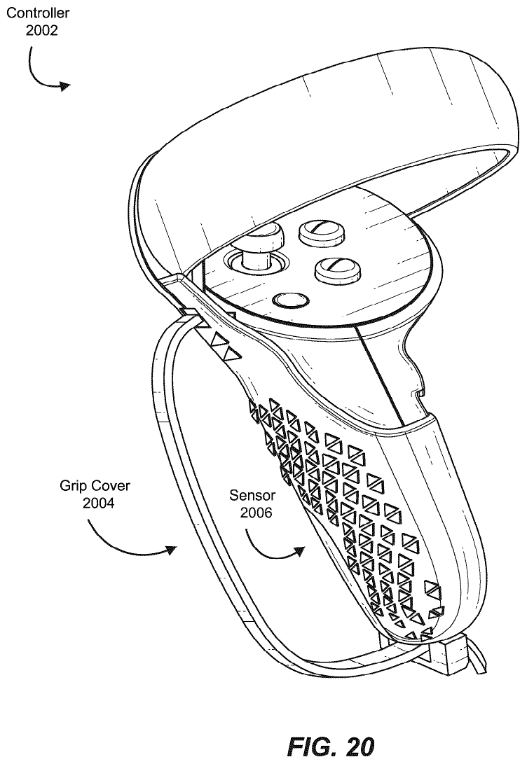

FIG. 19 is an illustration of an exemplary controller integrated with heart rate sensors in a battery cover that may be palm facing. For example, controller 1902 may include a battery cover 1904 integrated with heart rate sensors that are palm facing. FIG. 20 is an illustration of an exemplary controller with heart rate sensors integrated in a grip cover for the controller. In some embodiments, controller 2002 may include a grip cover 2004 that has heart rate sensors 2006 integrated in the grip cover 2004. In further embodiments, grip cover 2004 may include sensors 2006 in the areas of controller 2002 that a hand may grip for greater detectability.

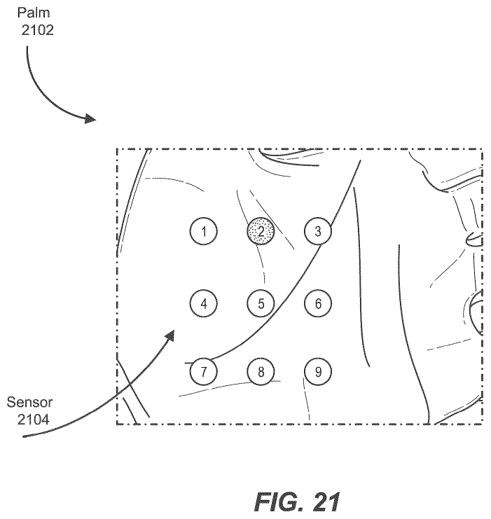

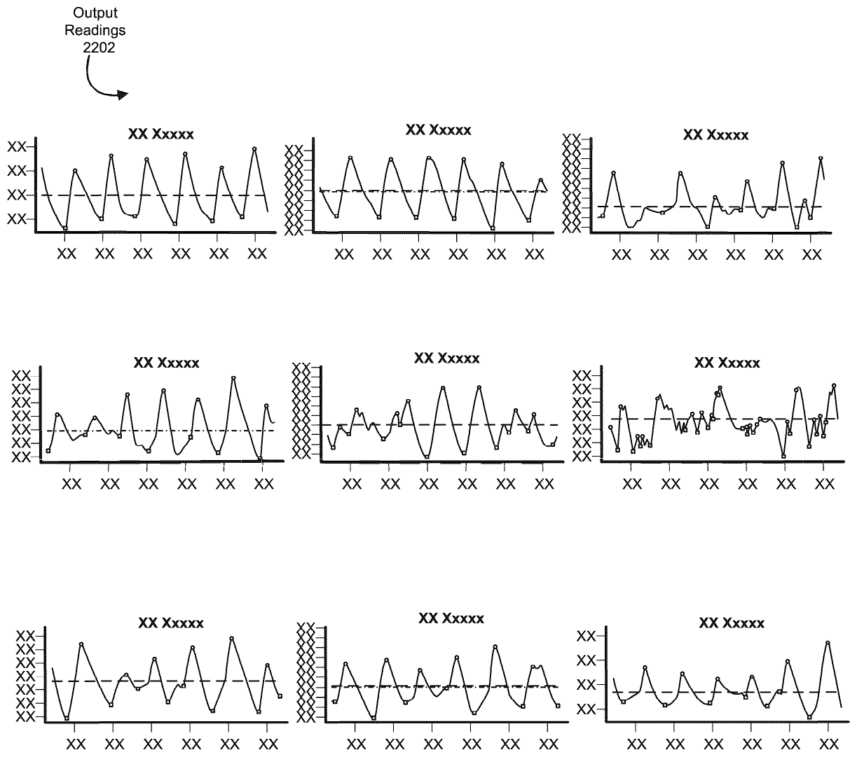

FIG. 21 is an illustration of an exemplary palm of a user including an array of sensors for heart rate monitoring. Sensors 2104 may span across a palm 2102 of the user to evaluate which sensor may have the best signal. In some embodiments, during calibration of the sensors 2104, the user may perform movements instructed to determine the optimal sensing location. As shown earlier in FIG. 16, upon evaluating the output readings of the sensors, the channels of the sensors with the best signal quality are turned on for heart rate monitoring. In some embodiments, sensors 2104 may be fit to span across different palm geometries of a user to ensure the most accurate heart rate monitoring regardless of the length, width, or size of the palm.

FIG. 22 is an illustration of exemplary output readings for heart rate sensors. Output readings 2202 may include the reading for each of the sensors from the array that detect a user's grip. In some embodiments, the output readings 2202 may evaluate to determine which sensor has the strongest signal quality for heart rate monitoring. For example, sensor 2104 may have the strongest signal out of output readings 2202 making it a candidate for heart rate monitoring on that location of a user's palm.

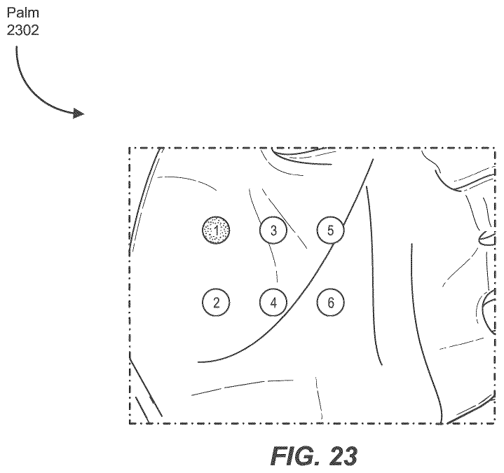

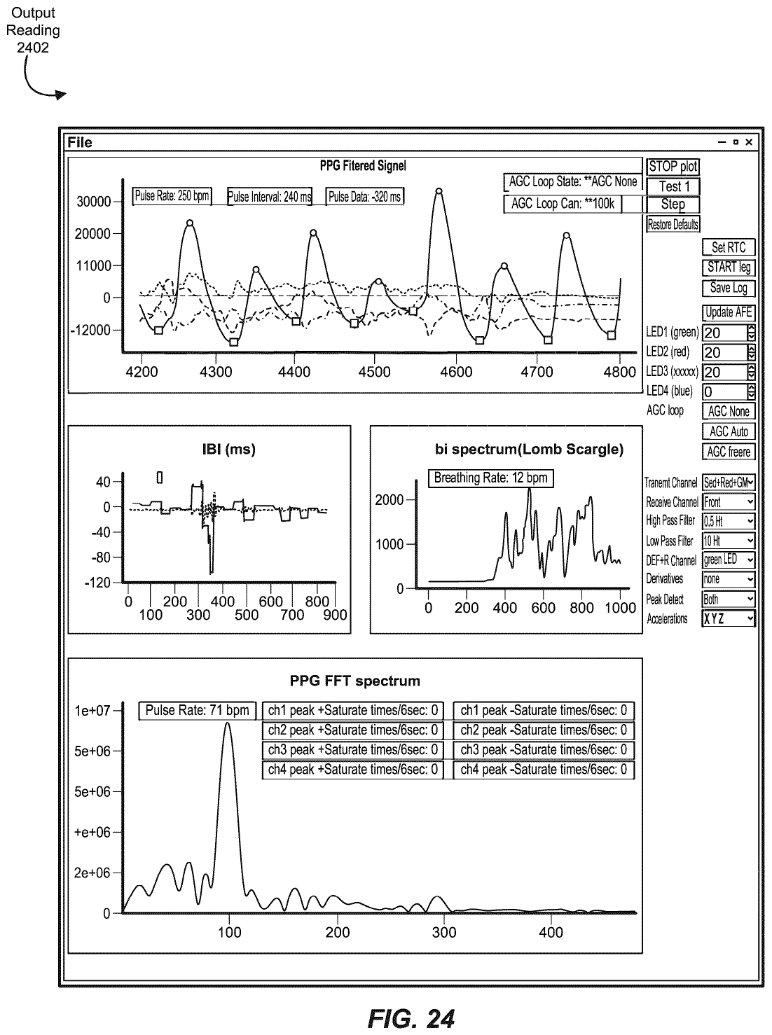

FIG. 23 is an illustration of an exemplary palm of a user including an array of heart rate sensors during a mid-intensity boxing motion, highlighting a sensor at an upper left corner of the palm. Palm 2302 may include an array of heart rate sensors, where each sensor is evaluated to determine the best sensing location for heart rate monitoring during boxing. FIG. 24 is an illustration of the output reading 2402 of a sensor at the upper left corner of the palm. Output reading 2402 may detail the strength of the PPG signal as well as the pulse rate of the user. In some embodiments, this sensor may compare its output reading against other sensors to determine the best signal quality.

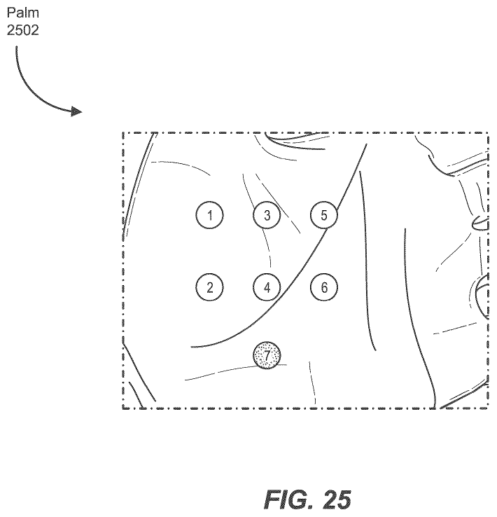

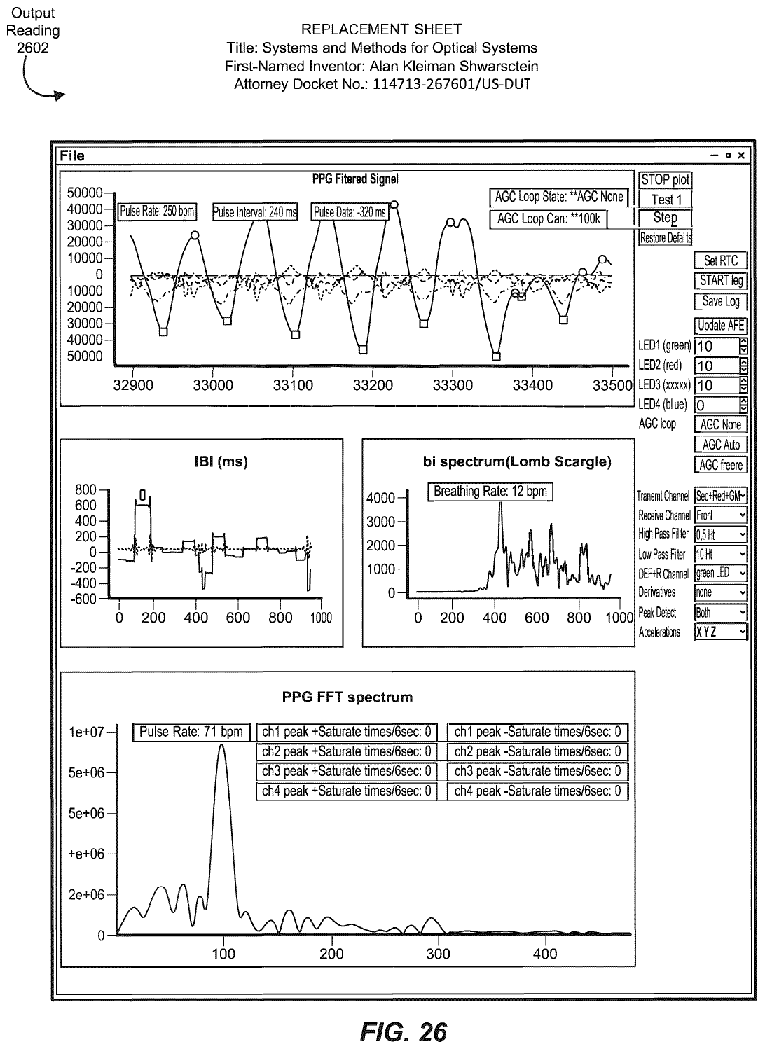

FIG. 25 is an illustration of an exemplary palm of a user including an array of heart rate sensors during a mid-intensity boxing motion, highlighting a sensor at the bottom of the palm. Palm 2502 may include an array of heart rate sensors, where each sensor is evaluated to determine the best sensing location for heart rate monitoring during boxing. FIG. 26 is an illustration of the output reading 2602 of a sensor at the bottom of the palm. Output reading 2602 may detail the strength of the PPG signal as well as the pulse rate of the user. In some embodiments, the sensor at the bottom of the palm may compare its output reading against other sensors to determine the best signal quality.

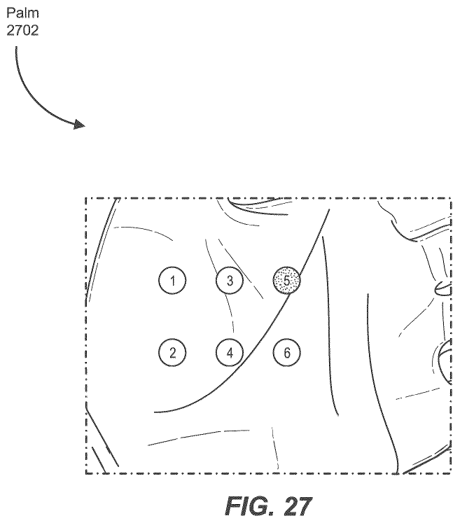

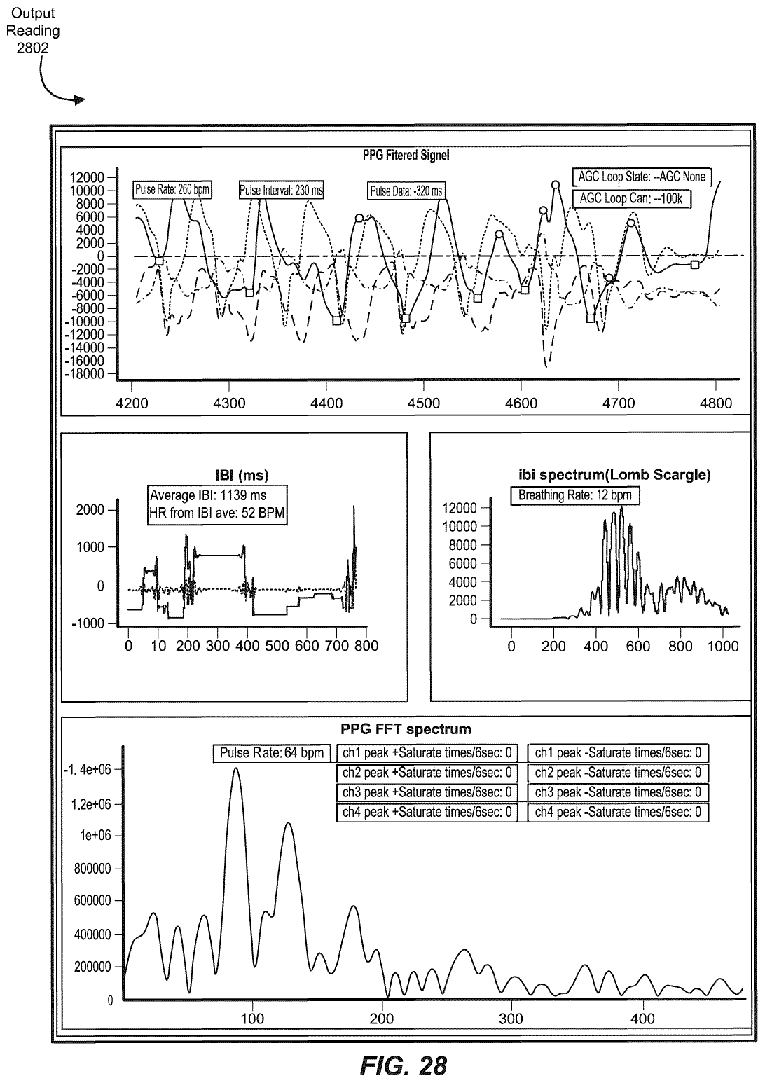

FIG. 27 is an illustration of an exemplary palm of a user including an array of heart rate sensors during a mid-intensity boxing motion, highlighting a sensor at the upper right corner of the palm. Palm 2702 may include an array of heart rate sensors, where each sensor is evaluated to determine the best sensing location for heart rate monitoring during boxing. FIG. 28 is an illustration of the output reading 2802 of a sensor at the upper right corner of the palm. Output reading 2802 may detail the strength of the PPG signal as well as the pulse rate of the user. In some embodiments, the sensor at the upper right corner of the palm may compare its output reading against other sensors to determine the best signal quality.

### Example Embodiments

Example 1: A method includes forming a lens block over a substrate, forming a nanostructured coating over the lens block opposite to the substrate, and hardening the lens block.

Example 2: The method of Example 1, where the lens block includes a reflowable polymer.

Example 3: The method of any of Examples 1 and 2, where the nanostructured coating is formed directly over the lens block.

Example 4: The method of any of Examples 1-3, where forming the nanostructured coating includes oblique angle deposition.

Example 5: The method of any of Examples 1-4, where the nanostructured coating includes a nanotextured polymer or an organic matrix having a nanoscale filler.

Example 6: The method of any of Examples 1-5, where the nanostructured coating includes a nanoporous oxide.

Example 7: The device including (i) an antenna, (ii) a printed circuit board having a side-plated contact, and (iii) an antenna carrier that includes an integrated spring having a conductive surface and is dimensioned to hold the antenna next to the printed circuit board such that the conductive surface is communicatively coupled to the side-plated contact.

Example 8: The device of Example 7, where the integrated spring includes a cantilevered spring.

Example 9: The device of any of Examples 7-8, where the conductive surface is deposited on the integrated spring via laser direct structuring.

Example 10: The subtractive contrast system including (i) a dark source that introduces laser pulses into a user's eyes to temporarily reduce photosensitivity of the user's eyes, (ii) a steering mechanism that applies the dark source to one or more regions of an augmented reality display, and (iii) a rendering pipeline that renders the augmented reality display incorporating the dark source.

Example 11: The subtractive contrast system of Example 10, where further including a gaze estimation subsystem that determines a viewing direction of the user's eyes relative to a surrounding environment.

Example 12: The subtractive contrast system of any of Examples 10-11, further including an environment awareness subsystem that determines light levels of a surrounding environment.

Example 13: The subtractive contrast system of any of Examples 10-12, where the dark source comprises an additional channel in an RGB augmented reality projector.

Example 14: The subtractive contrast system of any of Examples 10-13, where the steering mechanism applies the dark source to one or more regions of the augmented reality display that correspond to placement of one or more virtual objects within the augmented reality display.

Example 15: The subtractive contrast system of any of Examples 10-14, where the steering mechanism applies the dark source to one or more regions of the augmented reality display that correspond to placement of one or more virtual objects within the augmented reality display by applying the dark source such that it appears as though a dim halo exists around the one or more virtual objects while a remainder of a surrounding environment appears unchanged within the augmented reality display.

Example 16: The subtractive contrast system of any of Examples 10-15, further including an additive contrast subsystem that decreases a brightness level of one or more additional regions of the augmented reality display such that all regions of the augmented reality display are evenly illuminated by the dark source in concert with the additive contrast subsystem.

Example 17: The method including calibrating an array of heart rate sensors of a handheld device by (i) evaluating, while the handheld device is being held by a user, an output of each sensor in the sensor array, and (ii) selecting, based on the evaluation of the output of each sensor, a subset of sensors in the sensor array for us in detecting a hear rate of a user, and (iii) using the subset of sensors to monitor the heart rate of the user.

Example 18: The method of Example 17, where the evaluation is based on a strength of a signal quality.

Example 19: The method of any of Examples 17-18, further including calibrating the array of heart rate sensors in response to detecting a reduction signal quality from at least one sensor in the subset of sensors.

Example 20: The method of any of Examples 17-19, further including detecting movement of the handheld device, where the calibrating the array of heart rate sensors is performed in response to detecting the movement.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality—systems may be designed to work without near-eye displays (NEDs). Other artificial-reality systems may include an NED that also provides visibility into the real world (such as, e.g., augmented reality system 2900 in FIG. 29) or that visually immerses a user in an artificial reality (such as, e.g., virtual-reality system 3000 in FIG. 30). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 29, augmented-reality system 2900 may include an eyewear device 2902 with a frame 2910 configured to hold a left display device 2915(A) and a right display device 2915(B) in front of a user's eyes. Display devices 2915(A) and 2915(B) may act together or independently to present an image or series of images to a user. While augmented-reality system 2900 includes two displays, embodiments of this disclosure may be implemented in augmented-reality systems with a single NED or more than two NEDs.

In some embodiments, augmented-reality system 2900 may include one or more sensors, such as sensor 2940. Sensor 2940 may generate measurement signals in response to motion of augmented-reality system 2900 and may be located on substantially any portion of frame 2910. Sensor 2940 may represent one or more of a variety of different sensing mechanisms, such as a position sensor, an inertial measurement unit (IMU), a depth camera assembly, a structured light emitter and/or detector, or any combination thereof. In some embodiments, augmented-reality system 2900 may or may not include sensor 2940 or may include more than one sensor. In embodiments in which sensor 2940 includes an IMU, the IMU may generate calibration data based on measurement signals from sensor 2940. Examples of sensor 2940 may include, without limitation, accelerometers, gyroscopes, magnetometers, other suitable types of sensors that detect motion, sensors used for error correction of the IMU, or some combination thereof.

In some examples, augmented-reality system 2900 may also include a microphone array with a plurality of acoustic transducers 2920(A)-2920(J), referred to collectively as acoustic transducers 2920. Acoustic transducers 2920 may represent transducers that detect air pressure variations induced by sound waves. Each acoustic transducer 2920 may be configured to detect sound and convert the detected sound into an electronic format (e.g., an analog or digital format). The microphone array in FIG. 29 may include, for example, ten acoustic transducers: 2920(A) and 2920(B), which may be designed to be placed inside a corresponding ear of the user, acoustic transducers 2920(C), 2920(D), 2920(E), 2920(F), 2920(G), and 2920(H), which may be positioned at various locations on frame 2910, and/or acoustic transducers 2920(I) and 2920(J), which may be positioned on a corresponding neckband 2905.

In some embodiments, one or more of acoustic transducers 2920(A)-(J) may be used as output transducers (e.g., speakers). For example, acoustic transducers 2920(A) and/or 2920(B) may be earbuds or any other suitable type of headphone or speaker.

The configuration of acoustic transducers 2920 of the microphone array may vary. While augmented-reality system 2900 is shown in FIG. 29 as having ten acoustic transducers 2920, the number of acoustic transducers 2920 may be greater or less than ten. In some embodiments, using higher numbers of acoustic transducers 2920 may increase the amount of audio information collected and/or the sensitivity and accuracy of the audio information. In contrast, using a lower number of acoustic transducers 2920 may decrease the computing power required by an associated controller 2950 to process the collected audio information. In addition, the position of each acoustic transducer 2920 of the microphone array may vary. For example, the position of an acoustic transducer 2920 may include a defined position on the user, a defined coordinate on frame 2910, an orientation associated with each acoustic transducer 2920, or some combination thereof.

Acoustic transducers 2920(A) and 2920(B) may be positioned on different parts of the user's ear, such as behind the pinna, behind the tragus, and/or within the auricle or fossa. Or, there may be additional acoustic transducers 2920 on or surrounding the ear in addition to acoustic transducers 2920 inside the ear canal. Having an acoustic transducer 2920 positioned next to an ear canal of a user may enable the microphone array to collect information on how sounds arrive at the ear canal. By positioning at least two of acoustic transducers 2920 on either side of a user's head (e.g., as binaural microphones), augmented-reality device 2900 may simulate binaural hearing and capture a 3D stereo sound field around about a user's head. In some embodiments, acoustic transducers 2920(A) and 2920(B) may be connected to augmented-reality system 2900 via a wired connection 2930, and in other embodiments acoustic transducers 2920(A) and 2920(B) may be connected to augmented-reality system 2900 via a wireless connection (e.g., a BLUETOOTH connection). In still other embodiments, acoustic transducers 2920(A) and 2920(B) may not be used at all in conjunction with augmented-reality system 2900.

Acoustic transducers 2920 on frame 2910 may be positioned in a variety of different ways, including along the length of the temples, across the bridge, above or below display devices 2915(A) and 2915(B), or some combination thereof. Acoustic transducers 2920 may also be oriented such that the microphone array is able to detect sounds in a wide range of directions surrounding the user wearing the augmented-reality system 2900. In some embodiments, an optimization process may be performed during manufacturing of augmented-reality system 2900 to determine relative positioning of each acoustic transducer 2920 in the microphone array.

In some examples, augmented-reality system 2900 may include or be connected to an external device (e.g., a paired device), such as neckband 2905. Neckband 2905 generally represents any type or form of paired device. Thus, the following discussion of neckband 2905 may also apply to various other paired devices, such as charging cases, smart watches, smart phones, wrist bands, other wearable devices, hand-held controllers, tablet computers, laptop computers, other external compute devices, etc.

As shown, neckband 2905 may be coupled to eyewear device 2902 via one or more connectors. The connectors may be wired or wireless and may include electrical and/or non-electrical (e.g., structural) components. In some cases, eyewear device 2902 and neckband 2905 may operate independently without any wired or wireless connection between them. While FIG. 29 illustrates the components of eyewear device 2902 and neckband 2905 in example locations on eyewear device 2902 and neckband 2905, the components may be located elsewhere and/or distributed differently on eyewear device 2902 and/or neckband 2905. In some embodiments, the components of eyewear device 2902 and neckband 2905 may be located on one or more additional peripheral devices paired with eyewear device 2902, neckband 2905, or some combination thereof.

Pairing external devices, such as neckband 2905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 2900 may be provided by a paired device or shared between a paired device and an eyewear device, thus reducing the weight, heat profile, and form factor of the eyewear device overall while still retaining desired functionality. For example, neckband 2905 may allow components that would otherwise be included on an eyewear device to be included in neckband 2905 since users may tolerate a heavier weight load on their shoulders than they would tolerate on their heads. Neckband 2905 may also have a larger surface area over which to diffuse and disperse heat to the ambient environment. Thus, neckband 2905 may allow for greater battery and computation capacity than might otherwise have been possible on a stand-alone eyewear device. Since weight carried in neckband 2905 may be less invasive to a user than weight carried in eyewear device 2902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 2905 may be communicatively coupled with eyewear device 2902 and/or to other devices. These other devices may provide certain functions (e.g., tracking, localizing, depth mapping, processing, storage, etc.) to augmented-reality system 2900. In the embodiment of FIG. 29, neckband 2905 may include two acoustic transducers (e.g., 2920(l) and 2920(J)) that are part of the microphone array (or potentially form their own microphone subarray). Neckband 2905 may also include a controller 2925 and a power source 2935.

Acoustic transducers 2920(I) and 2920(J) of neckband 2905 may be configured to detect sound and convert the detected sound into an electronic format (analog or digital). In the embodiment of FIG. 29, acoustic transducers 2920(l) and 2920(J) may be positioned on neckband 2905, thereby increasing the distance between the neckband acoustic transducers 2920(I) and 2920(J) and other acoustic transducers 2920 positioned on eyewear device 2902. In some cases, increasing the distance between acoustic transducers 2920 of the microphone array may improve the accuracy of beamforming performed via the microphone array. For example, if a sound is detected by acoustic transducers 2920(C) and 2920(D) and the distance between acoustic transducers 2920(C) and 2920(D) is greater than, e.g., the distance between acoustic transducers 2920(D) and 2920(E), the determined source location of the detected sound may be more accurate than if the sound had been detected by acoustic transducers 2920(D) and 2920(E).

Controller 2925 of neckband 2905 may process information generated by the sensors on neckband 2905 and/or augmented-reality system 2900. For example, controller 2925 may process information from the microphone array that describes sounds detected by the microphone array. For each detected sound, controller 2925 may perform a direction-of-arrival (DOA) estimation to estimate a direction from which the detected sound arrived at the microphone array. As the microphone array detects sounds, controller 2925 may populate an audio data set with the information. In embodiments in which augmented-reality system 2900 includes an inertial measurement unit, controller 2925 may compute all inertial and spatial calculations from the IMU located on eyewear device 2902. A connector may convey information between augmented-reality system 2900 and neckband 2905 and between augmented-reality system 2900 and controller 2925. The information may be in the form of optical data, electrical data, wireless data, or any other transmittable data form. Moving the processing of information generated by augmented-reality system 2900 to neckband 2905 may reduce weight and heat in eyewear device 2902, making it more comfortable to the user.

Power source 2935 in neckband 2905 may provide power to eyewear device 2902 and/or to neckband 2905. Power source 2935 may include, without limitation, lithium-ion batteries, lithium-polymer batteries, primary lithium batteries, alkaline batteries, or any other form of power storage. In some cases, power source 2935 may be a wired power source. Including power source 2935 on neckband 2905 instead of on eyewear device 2902 may help better distribute the weight and heat generated by power source 2935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 3000 in FIG. 30, that mostly or completely covers a user's field of view. Virtual-reality system 3000 may include a front rigid body 3002 and a band 3004 shaped to fit around a user's head. Virtual-reality system 3000 may also include output audio transducers 3006(A) and 3006(B). Furthermore, while not shown in FIG. 30, front rigid body 3002 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 2900 and/or virtual-reality system 3000 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 2900 and/or virtual-reality system 3000 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 2900 and/or virtual-reality system 3000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a lens that comprises or includes a UV curable resin include embodiments where a lens consists essentially of a UV curable resin and embodiments where a lens consists of a UV curable resin.

1. A method comprising:
forming a lens block over a substrate;
forming a nanostructured coating over the lens block opposite to the substrate; and
hardening the lens block.

2. The method of claim 1, wherein the lens block comprises a reflowable polymer.

3. The method of claim 1, comprising forming the nanostructured coating directly over the lens block.

4. The method of claim 1, wherein forming the nanostructured coating comprises oblique angle deposition.

5. The method of claim 1, wherein the nanostructured coating comprises a nanotextured polymer or an organic matrix comprising a nanoscale filler.

6. The method of claim 1, wherein the nanostructured coating comprises a nanoporous oxide.

7. A device comprising:
an antenna;
a printed circuit board having a side-plated contact; and
an antenna carrier that:
comprises an integrated spring having a conductive surface; and
is dimensioned to hold the antenna next to the printed circuit board such that the conductive surface is communicatively coupled to the side-plated contact.

8. The device of claim 7, wherein the integrated spring comprises a cantilevered spring.

9. The device of claim 7, wherein the conductive surface is deposited on the integrated spring via laser direct structuring.

10. A subtractive contrast system comprising:
a dark source that introduces laser pulses into a user's eyes to temporarily reduce photosensitivity of the user's eyes;
a steering mechanism that applies the dark source to one or more regions of an augmented reality display; and
a rendering pipeline that renders the augmented reality display incorporating the dark source.

11. The subtractive contrast system of claim 10, further comprising a gaze estimation subsystem that determines a viewing direction of the user's eyes relative to a surrounding environment.

12. The subtractive contrast system of claim 10, further comprising an environment awareness subsystem that determines light levels of a surrounding environment.

13. The subtractive contrast system of claim 10, wherein the dark source comprises an additional channel in an RGB augmented reality projector.

14. The subtractive contrast system of claim 10, wherein the steering mechanism applies the dark source to one or more regions of the augmented reality display that correspond to placement of one or more virtual objects within the augmented reality display.

15. The subtractive contrast system of claim 10, wherein the steering mechanism applies the dark source to one or more regions of the augmented reality display that correspond to placement of one or more virtual objects within the augmented reality display by applying the dark source such that it appears as though a dim halo exists around the one or more virtual objects while a remainder of a surrounding environment appears unchanged within the augmented reality display.

16. The subtractive contrast system of claim 10, further comprising an additive contrast subsystem that decreases a brightness level of one or more additional regions of the augmented reality display such that all regions of the augmented reality display are evenly illuminated by the dark source in concert with the additive contrast subsystem.

17. A method comprising:
calibrating an array of heart rate sensors of a handheld device by:
evaluating, while the handheld device is being held by a user, an output of each sensor in the sensor array;
selecting, based on the evaluation of the output of each sensor, a subset of sensors in the sensor array for use in detecting a heart rate of a user; and
using the subset of sensors to monitor the heart rate of the user.

18. The method of claim 17, wherein the evaluation is based on a strength of a signal quality.

19. The method of claim 17, further comprising calibrating the array of heart rate sensors in response to detecting a reduction signal quality from at least one sensor in the subset of sensors.

20. The method of claim 17, further comprising detecting movement of the handheld device, wherein the calibrating the array of heart rate sensors is performed in response to detecting the movement.
